(19) United States
(12) Patent Application Publication
(10) Pub. No.: US 2019/0174202 A1
(43) Pub. Date: Jun. 6, 2019

(54) SYSTEM AND METHOD FOR AN INTERACTIVE LIVE STREAMING MEDIA PLATFORM TO LIMITED SUBSCRIBERS

(71) Applicant: BITLUME INC., Sammamish, WA (US)

(72) Inventor: Lakshmi Shankar, Sammamish, WA (US)

(21) Appl. No.: 16/093,573

(22) PCT Filed: May 17, 2016
(86) PCT No.: PCT/US2016/000042

§ 371 Date: Oct. 12, 2018

(51) Int. Cl. H04N 21/81; G06Q 20/12; H04N 21/2187; H04N 21/258; H04N 21/2543; H04N 21/478; H04N 21/472; H04N 21/431

(52) U.S. Cl. CPC H04N 21/812; G06Q 20/127; H04N 21/2187; H04N 21/25891; G06Q 50/01; H04N 21/4781; H04N 21/47202; H04N 21/4312; H04N 21/2543

(57) ABSTRACT

[1] In an online streaming service embodying the invention, the service would allow a content owner to retain their property rights in the video produced and uploaded by the channel owner. [2] In accordance with the invention, the streaming service would allow a content owner to monetize live events by charging different fees to viewers based on the amount of time they want access, the type of content, and various other factors. [3] In a method embodying the invention, the channel owners can gauge usage based on pre subscription and viewer interest by tracking click rates and subscription confirmation.

### TECHNICAL FIELD

The invention relates generally to the field of live streaming video online to multiple users.

### BACKGROUND ART

Online sites typically allow video to be uploaded, but the content owner loses their property rights in the video. The streaming sites also do not offer a comprehensive solution for the content owner to pre-schedule and monetize live and on-demand streaming, as opposed to the streaming service making revenue from advertising. The content owners do not get the privilege to choose the ads that run during their program.

Channel owners who manage live streaming often make a wild guess while gauging live stream bandwidth and pre-purchase bandwidth based on an estimate. At times due to high or low demand for the type and quality of content offered by the channel owner, viewers either under subscribe or oversubscribe for the streaming service. The channel owner does not have a predictive mechanism to gauge reasonable bandwidth usage. Often times due to over subscription the bandwidth spikes resulting in bad or choked delivery for the end users. For under subscribed services the pre purchased bandwidth usage will go unused but paid for.

### SUMMARY OF INVENTION

In an online streaming service embodying the invention, the service would allow a content owner to retain their property rights in the video produced and uploaded by the channel owner.

In accordance with the invention, the streaming service would allow a content owner to monetize live events by charging different fees to viewers based on the amount of time they want access, the type of content, and various other factors.

In a method embodying the invention, the channel owners can gauge usage based on pre subscription and viewer interest by tracking click rates and subscription confirmation.

### BRIEF DESCRIPTION OF DRAWINGS

The figures illustrate the invention by way of example, and not limitation. Life references indicate similar elements.

FIG. 1 illustrates a system including one embodiment of a live and on-demand streaming platform for multiple users.

FIG. 2 illustrates a system including one embodiment of a live and on-demand streaming platform that broadcasts audio and video for multiple users and can display content on multiple devices and accept content from multiple devices.

FIG. 3 illustrates an example of a user interface for one embodiment of the live and on-demand streaming platform.

FIG. 4 illustrates a system including one embodiment of a live and on-demand streaming platform that broadcasts audio and video for multiple users, where the users can view different channels, as well as create multiple channels.

FIG. 5 illustrates a system including one embodiment of a split screen chat window and live stream broadcast.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent applications mentioned herein are incorporated herein in their entirety.

It is also noted that as used herein and in the appended claims, the singular forms “a”, “and”, and “the” include plural referents unless the context clearly dictates otherwise. In the claims, the terms “first,” “second”, and so forth are to be interpreted merely as ordinal designations they shall not be limited in themselves. Further, the use of exclusive terminology such as “solely,” “only” and the like in connection with the recitation of any claim element is contemplated. Also, it is contemplated that any element indicated to be optional herein may be specifically excluded from a given claim by way of a “negative” limitation. Finally, it is contemplated that any optional feature of the inventive variation(s) described herein may be set forth and claimed independently or in combination with any one or more of the features described herein.

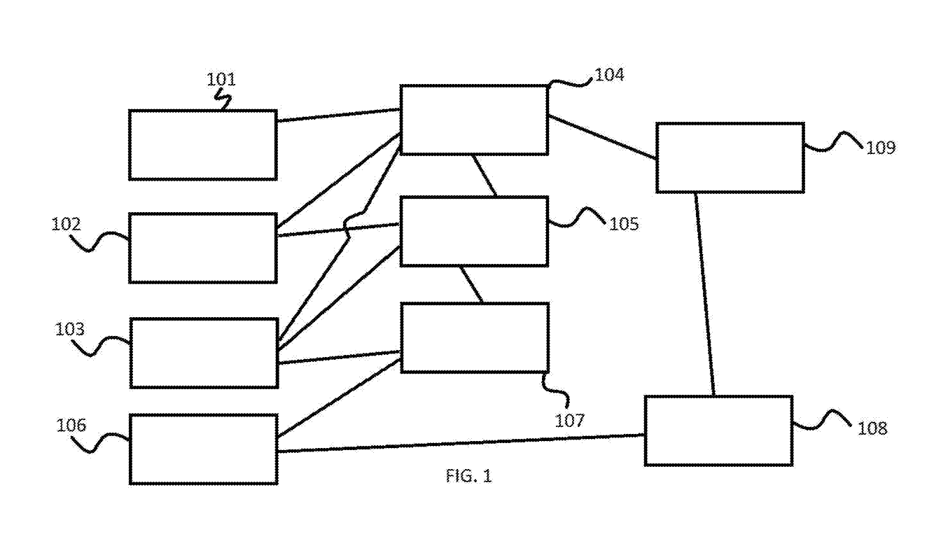

FIG. 1

FIG. 1 illustrates a system including one embodiment of a live and on-demand streaming platform for multiple users that allows users to watch live and on-demand, videographers to record games and livestream them, and allows organizations to create, manage and control their channels and so control the content and users who participate in this process.

This paragraph lists the elements of FIG. 1. FIG. 1 includes a system with multiple parts: a subscriber 101, a subscriber 102, a subscriber 103, a live and on-demand streaming platform 104, a channel owner 105, a videographer 106, a scheduler 107, a recording 108, a live stream broadcast 109, a channel 110 and an ad sponsor 111. Various elements of FIG. 1 have now been listed.

Channel Management

This paragraph describes some interconnections between the elements of FIG. 1. The channel owner 105 will register to the live and on-demand streaming platform 104. The channel owner 105 creates a dedicated channel 110. The channel owner 105 sets up channel branding, tiered subscription, and payment for the dedicated channel 110. The channel owner 105 sets up schedules for single or multiple concurrent live streaming. The channel owner 105 either invites a videographer 106 to the live stream broadcast 109 of channel 110, or the channel owner 105 assigns a videographer 106 to the live stream broadcast 109 of channel 110. The channel owner 105 can invite an ad sponsor 111 to put an ad on the channel 110. The channel owner 105 can also accept or reject an offer to put an ad on the channel 105 from the ad sponsor 111. The channel owner 105 can invite a subscriber 101 to join the channel 110. The channel owner 105 can also accept or reject a request from a subscriber 101 to join the channel 110. The channel owner 105 has content ownership rights depending on the type of service that they register for. The live stream broadcast 109 is uploaded on channel 110 as recording 108 if the channel owner 105 decides to make it available on-demand for subscribers who pay.

The live stream broadcast 109 or recording 108 can include, but is not limited to, a game, news, live event, performance, business activities, professional activities or general activities.

Subscription

The subscriber 101 registers on the live and on-demand streaming platform 104. The subscriber 101 registers to the invited channel or requests to join a channel 105, and if accepted, pays based on their desired level from tiered subscription. The subscriber 101 can also invite other subscribers 102 and 103 to join the channel 105 at any time, including during the live stream 109. Subscriber 101 can also pay for subscribers 102 and 103 if subscriber 101 wants. The subscriber 101 can watch the recording 108 of the live stream 109 at any time for as long as they have paid for access to the live stream 109 on channel 110. The subscriber 101 select other subscribers to the live stream broadcast 109 and chat with them in either a public or private group chat. The subscriber 101 can provide ratings of the live stream broadcast 109 or recording 108 through a rating widget. The subscriber 101 can provide comments on the live stream 109 or recording 108 through a public comment widget. The subscriber 101 can also share a link to the live stream 109 or recording 108 on social media, and any person who clicks on the link will have to become a subscriber to the channel 105 before being allowed to watch the live stream broadcast 109 or recording 108.

The subscriber 101 would pay based on the duration of the event they want to view. For example, a day pass is good for live stream viewing for a day, and a tournament pass is good for live stream viewing for 4 or 5 days, depending upon the tournament or event. These passes are exemplary, and do not limit the possible passes that may be available.

The subscriber 101 also has the option to register as a stream viewer to view all streams broadcasted by a channel owner.

Ad Sponsorship

The ad sponsor 111 either requests to place an ad on channel 110 that the channel owner 105 accepts, or the ad sponsor 111 accepts an invitation from the channel owner 105 to put an ad on channel 110. Then the ad sponsor 111 registers as an ad sponsor for the channel 110. Then the ad sponsor 111 uploads the content of the ad. The ad sponsor can accept or reject other invitations from other channels to run the uploaded ad. The ad sponsor can also restrict streaming of their ads to channels in which their competitor ad is streaming. The ad sponsor who participates in the channel ads is typically in support of the channel and their broadcasting content.

Stream Service

The live and on-demand streaming platform 104 is able to pre-calculate bandwidth for a single channel based on the preregistration, subscription and click rates, and assign desired bandwidth for the channel. The live and on-demand streaming platform 104 will send reminder notification to subscribers when the live streaming is about to begin.

Broadcasting

A videographer 106 can register on the live and on-demand streaming platform 104. A moderator makes sure the videographer 106 is qualified to film live events and can assign videographer 106 to a channel 110. The videographer can make himself or herself available to be assigned, or the videographer 106 can only accept invitations.

A videographer 106 accepts an invitation from a channel owner 105 to film the live stream broadcast 109 of a channel 110. Alternatively, the videographer 106 may be assigned by a channel owner 105 to film the live stream broadcast 109 of a channel 110. Then the videographer 106 register as a channel administrator for channel 110. On the day of the event, the videographer 106 records the game and broadcasts the live stream broadcast 109 on the live and on-demand streaming platform 104 using a broadcasting tool.

The videographer 106 may have multiple cameras assembled in the field or event area, which broadcast multiple streams to the broadcasting tool. The videographer 106 is able to switch between streams intermittently from various cameras, and sends out a single live stream broadcast 109 for broadcasting. The live stream broadcast 109 consists of audio and video. Some examples of the audio include, but are not limited to: live commentary, background music, or generic audio captured during the event. The live stream broadcast 109 is recorded as recording 108 for future use on channel 110 if the channel owner 105 authorizes it. The videographer 106 is able to start and stop the live stream broadcast 109 at certain points in the event, for example half time, break time or some other gap in time in the event. During these gaps, ads are run that the channel owner 105 has chosen from the ad sponsor 111. Multiple advertisements are lined up and streamed one after the other during the gap time. The videographer 106 is able to stop the advertisements and start the live stream broadcast 109 once the gap time is over.

The videographer 106 uses a score widget on channel 110 to broadcast the score of the game, if the event is a game. The channel 110 has a rating widget which a subscriber 101 can use to rate the quality of the live stream broadcast 109 or recording 108. The videographer 106 can use an announcement widget on the channel 110 to make announcements relevant to the event.

Only subscribers to channel 110 can view the Recording 108 or live stream broadcast 109, no one else is able to view the Recording 108 or live stream broadcast 109. Casual visitors to the live and on-demand streaming platform 104 will be able to watch a short preview of each channel broadcast, but to watch the full stream they have to subscribe and pay.

The live and on-demand streaming platform 104 is viewable on several devices, including but not limited to, a computer, a TV, a set top box connected to a TV, or a game console connected to a TV, or a smart TV, or a web TV, or a tablet, or a smart phone.

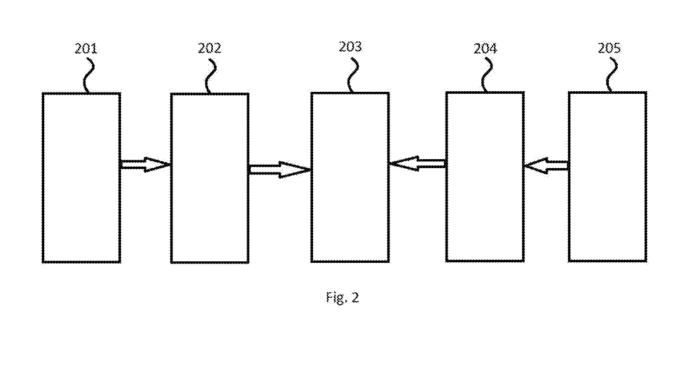

FIG. 2

FIG. 2 illustrates a system including one embodiment of a live and on-demand streaming platform that broadcasts audio and video for multiple users and can display content on multiple devices and accept content from multiple devices.

This paragraph lists the elements of FIG. 2. FIG. 2 includes a system with multiple parts: a subscriber 201, a viewing device 202, a live and on-demand streaming platform 203, a broadcasting tool 204, and a device for inputting content 205. Various elements of FIG. 2 have now been listed.

This paragraph describes some interconnections between the elements of FIG. 2. The subscriber 201 views live or recorded content from a viewing device 202. The viewing device 202 displays the live and on-demand streaming platform 203. The device for inputting content 205 records content and sends that content to a broadcasting tool 204. The broadcasting tool 204 is able to add brands and other visual information to the live stream or recording, after which the broadcasting tool 204 sends the possibly modified content to the live and on-demand streaming platform 203.

The viewing device 202 includes any device with a processor and a storage area. Some examples include but are not limited to, a computer, a TV, a set top box connected to a TV, or a game console connected to a TV, or a smart TV, or a web TV, or a tablet, or a smart phone.

The streaming and organizing service 203 can be either on a freemium model or a tiered subscription model. The live and on-demand streaming platform 203 can utilize one or more interactive widgets, such as the symbols for Facebook, Twitter, chat balloons, a heart, or an arrow, but is not limited to this list.

The broadcasting tool 204 can include, but is not limited to, Studio Pro Broadcaster, Branding Tools and Subscription Tools.

The device for inputting content 205 can include, but is not limited to, a video camera, a tripod standing video camera, a close circuit video camera, a personal video camera, a professional video camera with high quality sound intake, an aerial camera such as a camera attached to a drone, a mobile phone, a computer, or a tablet computer.

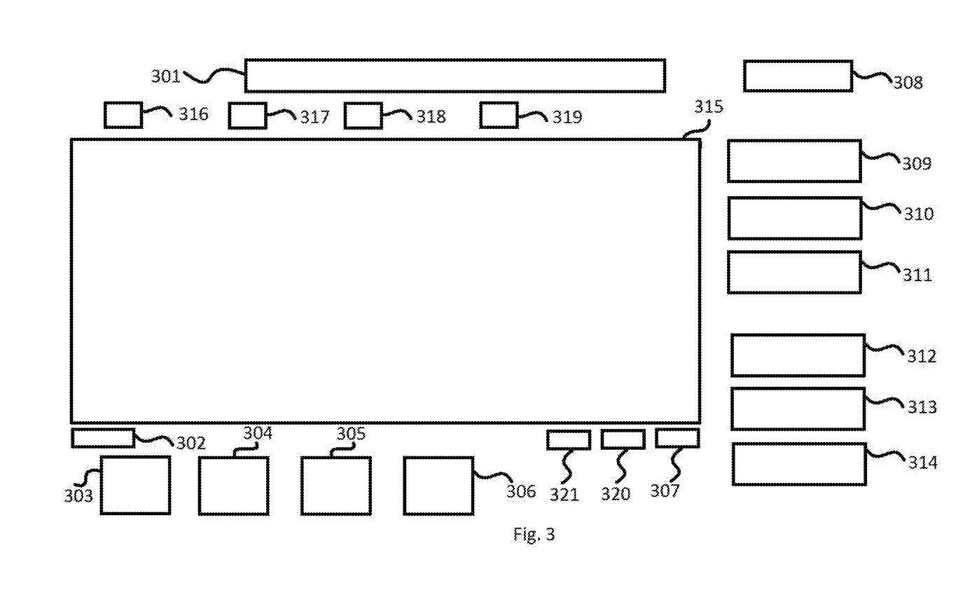

FIG. 3

FIG. 3 illustrates a user interface for one embodiment of the live and on-demand streaming platform.

FIG. 3 shows what one embodiment of the system's channel page would look like.

This paragraph lists the elements of FIG. 3. FIG. 3 includes a system with multiple parts: a search engine 301, a view count 302, a recent video 303, a recent video 304, a recent video 305, a recent video 306, a chat count icon 307, an account link 308, a live stream link 309, a live stream link 310, a live stream link 311, a future live stream link 312, a future live stream link 313, a future live stream link 314, a live stream 315, a widget 316, a widget 317, a widget 318, a widget 319, a watchlist icon 320, and a fanflag icon 321.

View count 302 displays how many subscribers are viewing the live stream 315.

Recent videos 303, 304, 305, and 306 show recordings that were former live streams, and are now available on-demand.

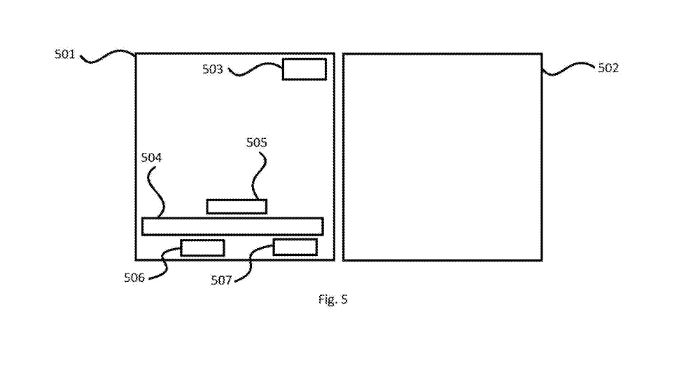

Chat count icon 307 shows the number of ongoing chats about live stream 315 within the streaming audio and video system. When a user clicks on chat count icon 307 it opens a chat window, which can be moved to either the left side or right side of the screen. This chat window is depicted in FIG. 5.

Account link 308 shows the subscriber's username and a link to their account, where they can add or remove themselves as subscribers to different channels.

Live stream links 309, 310, and 311 show links to other live streams that the user has subscribed to and might click on to view.

Future live stream links 312, 313 and 314 show links to live streams that have not yet started, that will be available at a certain point in the future.

Live stream 315 shows the event itself, live, directly from the videographer at the event, broadcast through the streaming audio and video system.

Widgets 316, 317, 318 and 319 are each a link to a different integration app that lets the user a link to the Live Stream 315 in the respective social media platform. For example, in one embodiment of the invention, Widget 316 would be a link to share the Live Stream 315 on Facebook, Widget 317 would be a link to share the Live Stream 315 on Twitter, Widget 318 would be a link to share the Live Stream 315 on Instagram, and Widget 319 would be a link to share the Live Stream 315 on Gmail. Each of widgets 316, 317, 318, and 319 will also share a preview of the Live Stream 315 and prompt for subscription at the end of the preview.

When a user clicks on Watchlist icon 320, the live stream 315 is added to the user's watchlist, such that the user will get reminders about the upcoming and live schedule. The reminders will be both in emails and when the user logs into the live and on-demand streaming platform.

When a user clicks on the fanflag icon 321, the user is supporting their favorite team, as in one of the teams competing in the live stream or on-demand video, if there is a team. The user will then be made available of other live stream broadcasts that involve their team, and will be offered the opportunity to subscribe to those live stream broadcasts.

An additional widget that is not illustrated is called “Q & A for Quiz”. A channel owner can include the “Q and A for Quiz” widget, which tests the user on various facts relevant to the event if they click on the widget.

An additional widget that is not illustrated is called the voting widget. A channel owner can include the voting widget which allows users to vote on the event when they click on the widget;

An additional widget that is not illustrated is called the “breaking news” widget. A channel owner can include a “breaking news” widget in order to broadcast news about the event or the subject generally when the subscriber clicks on the widget.

An additional widget that is not illustrated is called the “fan flag” widget. A channel owner can include a fan flag widget, which allows the user to support their favorite team, as in one of the teams competing in the live stream or on-demand video, if there is a team. The user will then be informed of other live stream broadcasts that involve their team, and will be offered the opportunity to subscribe to those live stream broadcasts.

FIG. 3 also illustrates a method in which the live streaming service measures subscribers and click rates. Click rates are the total subscriptions plus the number of people who have watched the preview without subscribing to the channel. The live streaming service then provides the number of subscribers and click rates to the channel owner. The live streaming service then provides the necessary bandwidth to accommodate subscribers of the channel based on the number of subscribers and the click rates, so that the live streamed video is of good quality, and does not pixelate due to a lack of bandwidth.

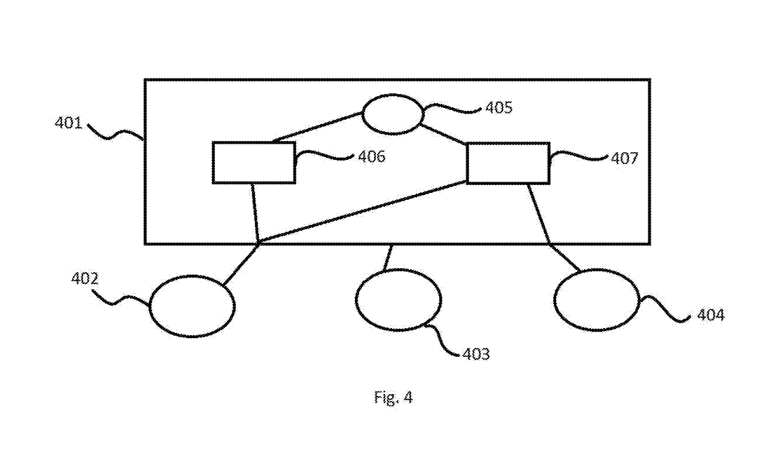

FIG. 4

FIG. 4 illustrates a system including one embodiment of a live and on-demand streaming platform that broadcasts audio and video for multiple users, where the users can view different channels, as well as create multiple channels.

This paragraph lists the elements of FIG. 4. FIG. 4 includes a system with multiple parts: a video streaming service 401, a user 402, a user 403, a user 404, a moderator 405, a channel 406 and a channel 407.

A user 402 can create a channel on the video streaming service 401. This channel can be viewed by other users, such as user 403, if user 403 subscribes to the channel and if user 402 allows user 403 to subscribe to the channel. User 402 can create multiple channels such as channels 406 and 407, which each have different sets of users that are subscribed to the channels. User 402 can also subscribe to multiple channels, so they can view multiple channels. If user 404 has created a channel 407 and user 402 wants to watch it, then user 402 subscribes to user 404's channel 407 and watches the live stream when it is broadcast, or on-demand at a later time.

Users can also comment on social media about a live stream or on-demand video being played from the live video streaming service 401. They can share the website link to the video through any number of social media options.

The video streaming service 401 has a moderator, which can eliminate channels if the channels have content that the moderator does not approve of. Users can also report to the moderator if they want to complain about a channel's content.

Once a user 402 creates a channel 406, they have the option to accept an advertisement that will play on their channel 406 during half time, break time, pre event or post event times.

A user is limited to viewing one live stream or on-demand recording across channels at a time, so as to better manage bandwidth. The moderator 405 manages bandwidth per channel by analyzing the subscribers to the live stream on the channel, subscribers to the channel, as well as the click rates of the channel.

FIG. 5

FIG. 5 illustrates one embodiment of a split screen chat window 501 and live stream broadcast 502. The invite button 503 allows a user to invite other users to the chat window 501. The text box 504 allows users to enter text or emojis into the text box 504 and display them on the chat window 501. The rating tool 506 allows users to rate the live stream broadcast 502. The rating display 507 shows the average rating of the live stream broadcast 502 from all users. The chat window can be moved from the left side to the right side, and vice versa.

### BEST MODE FOR CARRYING OUT THE INVENTION

Hereinafter, the present invention is described in more detail with reference to examples. However, the following examples are intended to illustrate the invention, and the scope of the invention is not limited to these examples. The examples can be properly corrected and modified by a person skilled in the art within the scope of the present invention.

### Example 1

The embodiment described in FIG. 1 along with the user interface described in FIG. 3 is the best mode of the invention.

What is claimed is:

1. A method performed by a computing system for operating an interactive live streaming media platform to limited subscribers, the computing system including a processor and storage area, the method comprising:
a channel owner registering on a live and on-demand streaming platform;
a channel owner creating a channel on the live and on-demand streaming platform;
a channel owner setting up channel branding, tiered subscription and payment on the channel;
a channel owner setting up schedules for single or multiple concurrent live streams;
a channel owner either inviting or assigning a videographer to film the live stream;
a channel owner inviting an ad sponsor to play ads during the breaks in the live stream;
a channel owner inviting a subscriber or subscribers to join the channel;
a channel owner either accepting or rejecting a request to join a channel from a subscriber;
a channel owner deciding to make the live stream available as on-demand video for subscribers;
a channel owner deciding to restrict the live stream or recording to be only viewed by subscribers to the channel.

2. The method of claim 1, the method further comprising:
subscribers registering on a live and on-demand streaming platform;
subscribers requesting to join a channel, and if accepted, paying the channel owner based on their desired level from tiered subscription;
subscribers inviting other subscribers to join a channel to watch a live stream at any time, including during the live stream;
subscribers paying the fees of other subscribers;
subscribers can watch a recording of the live stream at any time for as long as they have paid for access to the live stream on the channel;
subscribers selecting other subscribers to the live stream and chatting with them in a public or private group chat;
subscribers can provide ratings of the live stream or recording through a rating widget;
subscribers can provide comments on the live stream or recording through a public comment widget;
subscribers can also share a link to the live stream or recording on social media, and any person who clicks on the link will have to become a subscriber to the channel before being allowed to watch the live stream or recording;
subscribers pay either based on the duration of the event they want to view, or pay to watch all live streams and recordings available by a channel.

3. The method of claim 2, the method further comprising:
an ad sponsor making a request to place an ad on a channel, and then the channel owner either accepts or rejects the ad, or alternatively, an ad sponsor can accept an invitation from a channel owner to put an ad on a channel;
the ad sponsor registering as an ad sponsor for the channel;
the ad sponsor uploading the content of the ad;
the ad sponsor optionally using the ad for other channels as well;
the ad sponsor optionally restricting streaming of its ads to channels in which the ad sponsor's competitor's ads are streaming.

4. The method of claim 3, the method further comprising:
the live and on-demand streaming platform keeping track of the number of users who subscribe for a live stream, the number of subscribers a channel has, and the number of users who click on a link to the live stream or channel;
the live and on-demand streaming platform pre-calculating bandwidth for a single channel based on the number of subscribers to a live stream, the number of subscribers a channel has, and the number of users who click on a link to the live stream or channel;
the live and on-demand streaming platform assigning the calculated bandwidth for the channel;
the live and on-demand streaming platform making the following information available to the channel owner: the number of users who subscribe for a live stream, the number of subscribers a channel has, and the number of users who click on a link to the live stream or channel.

5. The method of claim 4, further comprising:
a videographer registering on the live and on-demand streaming platform;
a moderator making sure the videographer is qualified to film live events;
the videographer making himself or herself available to be assigned, or alternatively, the videographer can choose to only accept or reject invitations, and not be available to be assigned;
the videographer accepting an invitation from a channel owner to film the live stream of an event on a channel, or alternatively, the videographer may be assigned by a channel owner to film the live stream of an event on a channel;
the videographer registering as a channel administrator for the channel that will broadcast the live stream;
on the day of the event, the videographer recording the event and broadcasting the live stream on the live and on-demand streaming platform using a broadcasting tool;
the videographer possibly using multiple cameras assembled in the field or event area, in which the cameras broadcast multiple streams to the broadcasting tool;
the videographer intermittently switching between the streams from various cameras, and sending out a single live stream for broadcasting;
the videographer can start and stop the live stream at certain points in the event where there is a gap in activity;
during these gaps, ads run that the channel owner has chosen from the ad sponsor;
Multiple advertisements are lined up and streamed one after the other during the gap time;
the videographer is able to stop the ads and start the live stream once the gap time is over;
the live stream consists of video and audio, where the audio is live commentary;
the videographer optionally utilizing broadcasting modification software to modify the broadcast by adding visual content as the broadcast is being livestreamed;
the live stream is stored as a recording on the live and on-demand streaming platform;
if the channel owner authorizes it, the live stream is available as a recording to watch on-demand for subscribers to the channel where it was broadcast as a live stream, if the subscribers have paid for access to the on-demand recording.

6. The method of claim 5, the method further comprising:
subscribers using a rating widget on the channel to rate the quality of the live stream or recording;
a videographer using an announcement widget on the channel to make announcements relevant to the event;
if the event is a game, a videographer using score widget on a channel to broadcast the score of the game;
a channel owner including widget called “Q & A for Quiz”, which tests the user on various facts relevant to the event if they click on the widget;
a channel owner including voting widget which allows users to vote on the event when they click on the widget;
a channel owner including a “breaking news” widget in order to broadcast news about the event or the subject generally when the subscriber clicks on the widget.

7. The method of claim 6, the method further comprising:
a channel owner including a fan flag widget, which allows the user to support their favorite team, as in one of the teams competing in the live stream or on-demand video, if there is a team; the user will then be informed of other live stream broadcasts that involve their team, and will be offered the opportunity to subscribe to those live stream broadcasts.

8. The method of claim 7, the method further comprising:
A moderator analyzing recordings and ads and restricting them based on their content if the content is not appropriate for certain age groups.

9. A system for operating an interactive live streaming media platform to limited subscribers, the system comprising:
a processor;
a storage component;
a live stream of the event being filmed;
a recording of the live stream, which is available to view on-demand;
a channel configured to broadcast a live stream, and make it available as a recording for on-demand viewing;
a channel owner who creates a channel, invites subscribers and invites or assigns a videographer to film the event being broadcast;
at least one subscriber who subscribes to the live stream or channel and watch the live stream or recording on the channel;
an advertisement sponsor who submits an advertisement video to the channel owner for approval to broadcast during a live stream and recording;
an advertisement video created by the advertisement sponsor to broadcast during a live stream or recording;
a videographer who films the event with at least one camera, from which the videographer receives multiple streams into a broadcasting tool, with which he can switch from one stream to the next to create a continuous live stream;
a moderator who makes sure the videographer is qualified to film live events.

10. The system of claim 9, wherein the channel owner:
registers on a live and on-demand streaming platform;
creates a channel on the live and on-demand streaming platform;
sets up channel branding, tiered subscription and payment on the channel;
sets up schedules for single or multiple concurrent live streams;
invites an ad sponsor to play ads during the breaks in the live stream;
invites a subscriber or subscribers to join the channel;
either accepts or rejects a request to join a channel from a subscriber;
decides to make the live stream available as on-demand video for subscribers;
decides to restrict the live stream or recording to be only viewed by subscribers to the channel.

11. The system of claim 10, wherein at least one subscriber
registers on a live and on-demand streaming platform;
requests to join a channel, and if accepted, paying the channel owner based on their desired level from tiered subscription;
invites other subscribers to join a channel to watch a live stream at any time, including during the live stream;
pays the fees of other subscribers;
pay either based on the duration of the event they want to view, or pay to watch all live streams and recordings available by a channel;
has the option to watch a recording of the live stream at any time for as long as they have paid for access to the live stream on the channel;
has the option to select other subscribers to the live stream and chatting with them in a public or private group chat;
has the option to provide ratings of the live stream or recording through a rating widget;
has the option to provide comments on the live stream or recording through a public comment widget;
has the option to also share a link to the live stream or recording on social media, and any person who clicks on the link will have to become a subscriber to the channel before being allowed to watch the live stream or recording.

12. The system of claim 11, wherein the advertisement sponsor
makes a request to place an ad on a channel, and then the channel owner either accepts or rejects the ad, or alternatively, an ad sponsor can accept an invitation from a channel owner to put an ad on a channel;
registers as an advertisement sponsor for the channel;
uploads the content of the ad;
has the option to use the ad for other channels as well;
has the option to restrict streaming of its ads to channels in which the ad sponsor's competitor's ads are streaming.

13. The system of claim 12, wherein the live and on-demand streaming platform keeps track of the number of users who subscribe for a live stream, the number of subscribers a channel has, and the number of users who click on a link to the live stream or channel;
pre-calculates bandwidth for a single channel based on the number of subscribers to a live stream, the number of subscribers a channel has, and c;
assigns the calculated bandwidth for the channel;
makes the following information available to the channel owner: the number of users who subscribe for a live stream, the number of subscribers a channel has, and the number of users who click on a link to the live stream or channel.

14. The system of claim 13, wherein the videographer
registers on the live and on-demand streaming platform;
makes himself or herself available to be assigned, or alternatively, the videographer can choose to only accept or reject invitations, and not be available to be assigned;
accepts an invitation from a channel owner to film the live stream of an event on a channel, or alternatively, the videographer may be assigned by a channel owner to film the live stream of an event on a channel;
registers as a channel administrator for the channel that will broadcast the live stream;
records the event and broadcasts the live stream on the live and on-demand streaming platform using a broadcasting tool;
has the option to use multiple cameras assembled in the field or event area, in which the cameras broadcast multiple streams to the broadcasting tool;
has the option to intermittently switch between the streams from various cameras, and sending out a single live stream for broadcasting;
starts and stops the live stream at certain points in the event where there is a gap in activity;
during these gaps, ads Multiple advertisements are lined up and streamed one after the other during the gap time;
stops the ads and start the live stream once the gap time is over;
has the option to utilize broadcasting modification software to modify the broadcast by adding visual content as the broadcast is being livestreamed.

15. The system of claim 14, wherein the live streaming media platform
runs ads that the channel owner has chosen from the ad sponsor;
broadcasts live streams that consist of video and audio, where the audio is live commentary;
stores live streams as recordings on the same channel they were broadcasted as live streams;
If the channel owner authorizes it, makes the live stream available as a recording to watch on-demand for subscribers to the channel where it was broadcast as a live stream, if the subscribers have paid for access to the on-demand recording.

16. The system of claim 15, wherein the system is further configured such that subscribers have the option to use a rating widget on the channel to rate the quality of the live stream or recording;
a videographer has the option to use an announcement widget on the channel to make announcements relevant to the event;
if the event is a game, a videographer uses a score widget on a channel to broadcast the score of the game.
a channel owner has the option to include a widget called “Q & A for Quiz”, which tests the user on various facts relevant to the event if they click on the widget;
a channel owner has the option to include voting widget which allows users to vote on the event when they click on the widget;
a channel owner has the option to include a “breaking news” widget in order to broadcast news about the event or the subject generally when the subscriber clicks on the widget.

17. The system of claim 16, wherein the system is further configured such that
a channel owner has the option to include a fan flag widget, which allows the user to support their favorite team, as in one of the teams competing in the live stream or on-demand video, if there is a team; the user will then be informed of other live stream broadcasts that involve their team, and will be offered the opportunity to subscribe to those live stream broadcasts.

18. The system of claim 17, wherein the system is further configured such that
a moderator analyzes recordings and ads and restricts them based on their content if the content is not appropriate for certain age groups.
